(19) United States
(12) Patent Application Publication
(10) Pub. No.: US 2022/0171412 A1
(43) Pub. Date: Jun. 2, 2022

(54) AUTONOMOUS AERIAL VEHICLE OUTDOOR EXERCISE COMPANION

(71) Applicants: AT&T Intellectual Property I, L.P., Atlanta, GA (US); AT&T Mobility II LLC, Atlanta, GA (US)

(72) Inventors: Zhi Cui, Sugar Hill, GA (US); Sangar Dowlatkhah, Cedar Hill, TX (US); Sameena Khan, Peachtree Corners, GA (US); Troy Paige, Buford, GA (US); Ari Craine, Marietta, GA (US); Robert Koch, Peachtree Corners, GA (US)

(21) Appl. No.: 17/107,695

(22) Filed: Nov. 30, 2020

(51) Int. Cl. G05D 1/12; G05D 1/00; B64D 47/02; G08B 3/10; B64C 39/02; G02B 27/01

(52) U.S. Cl. CPC G05D 1/12; G05D 1/0055; G05D 1/0094; G05D 1/0038; B64D 47/02; G02B 2027/0178; B64C 39/024; G02B 27/0172; B64C 2201/126; B64C 2201/127; B64C 2201/146; G08B 3/10

(57) ABSTRACT

A processing system of an autonomous aerial vehicle including at least one processor may navigate the autonomous aerial vehicle to accompany a user, project a visible personal safety zone around the user, where the visible personal safety zone comprises at least a portion of a field of view of a camera of the autonomous aerial vehicle, and project visual information for the user on at least one surface in the vicinity of the user.

The present disclosure relates generally to autonomous vehicle operations, and more particularly to methods, computer-readable media, and apparatuses for an autonomous aerial vehicle to project a visible personal safety zone around a user and to project visual information for the user on at least one surface.

### BACKGROUND

Current trends in wireless technology are leading towards a future where virtually any object can be network-enabled and addressable on-network. The pervasive presence of cellular and non-cellular wireless networks, including fixed, ad-hoc, and/or or peer-to-peer wireless networks, satellite networks, and the like along with the migration to a 128-bit IPv6-based address space provides the tools and resources for the paradigm of the Internet of Things (IoT) to become a reality. In addition, drones or autonomous aerial vehicles (AAVs) are increasingly being utilized for a variety of commercial and other useful tasks, such as package deliveries, search and rescue, mapping, surveying, and so forth, enabled at least in part by these wireless communication technologies.

### SUMMARY

In one example, the present disclosure describes a method, computer-readable medium, and apparatus for an autonomous aerial vehicle to project a visible personal safety zone around a user and to project visual information for the user on at least one surface. For instance, in one example, a processing system of an autonomous aerial vehicle including at least one processor may navigate the autonomous aerial vehicle to accompany a user, project a visible personal safety zone around the user, where the visible personal safety zone comprises at least a portion of a field of view of a camera of the autonomous aerial vehicle, and project visual information for the user on at least one surface in a vicinity of the user.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates example scenes of an autonomous aerial vehicle accompanying a user during an exercise session, in accordance with the present disclosure;

FIG. 3 illustrates a flowchart of an example method for an autonomous aerial vehicle to project a visible personal safety zone around a user and to project visual information for the user on at least one surface; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for an autonomous aerial vehicle to project a visible personal safety zone around a user and to project visual information for the user on at least one surface. In particular, examples of the present disclosure provide an autonomous aerial vehicle (AAV) to serve as a safety companion for a user traversing a route. For instance, a user, who may be equipped with an electronic communication device, may be going for a jog along a route. The user may deploy an AAV to serve as a safety and informational companion, allowing for the user to receive more information about the surroundings, as gathered and displayed by the AAV.

In one example, a planned route may be established from Point A (e.g., a first location) to Point B (e.g., a second location). This planned route may be established, for instance, on a wireless device carried or worn by the user. The planned route may be sent to a first AAV (AAV1). AAV1 may belong to the user, or it may be beckoned via the user's wireless device to accompany the user during the traversal of the route. AAV1 may set its own course to follow the same route as is planned by the user. AAV1 may start the traversal of the route at a distance, d, from the user (e.g., in the direction of the route ahead). The starting distance, d, may be a default value, or specified by the user. As the user traverses the route, the user's wireless device may continually calculate the user's most recent pace along the route. As the user's most recent pace increases or decreases, AAV1 may accelerate or decelerate its lateral speed along the route to maintain the distance, d.

AAV1, while at the distance, d, ahead of the user, may use onboard sensors to detect conditions along the route. The sensors may include motion sensors, optical cameras, infrared cameras, acoustic sensors/microphones, a light detection and ranging (LiDAR) unit, a temperature sensor (e.g., a thermometer), other environmental sensors, and so forth. In one example, AAV1 may include a processing system that is configured to interpret sensor data. For instance, AAV1 may include modules, e.g., software executable by the processing system, such as a facial recognition module, image recognition module, a heat signature recognition module, and others. To illustrate, AAV1 may capture images via an optical camera and may detect a potentially dangerous situation by processing the images via the image recognition module, and may provide a safety alert to the user, e.g., via a loudspeaker or on-board projector, and/or via a message sent to the user's wireless device. Various dangerous situations may be detected via image recognition models stored in the image recognition module, or via various other detection models stored in the other modules associated with other types of sensor data. Example dangerous situations that may be detected include a dangerous animal, a pothole, an icy patch on a roadway, an obstacle (e.g., a fallen tree), an unidentified person (e.g., in a potentially threatening posture such as hiding or lurking behind a bush and the like), a person registered through a contact tracing system, an accident (e.g., a car crash, a collision between a cyclist and a pedestrian, and the like), or other potential situations for the user to avoid. In some cases, a situation to avoid may be out of the field of view of the user, such as behind a building, behind dense bushes, around a corner, etc. In one example, AAV1 may create and store a record of the dangerous situation that is detected, including sensor data, such as an image of a person, object, location, terrain, and/or scene that is detected.

Having detected a potential danger, AAV1 may provide an alert to the user. In one example, AAV1 may perform an image and/or spatial analysis of the user's field of view ahead of the user along the route, e.g., from images captured via AAV1's on-board optical camera and/or from AAV1's LiDAR unit. For instance, AAV1 may identify one or more suitable flat surfaces (or relatively flat surfaces) on which to project a visual alert. If a suitable surface is identified, AAV1 may identify the dimensions of the surface and position itself so as to project the alert onto the surface, such as: “Danger: icy pavement ahead 100 ft.” In another example, the alerting may be accomplished by AAV1 illuminating the area where the situation was detected, or illuminating the object(s) (which could be a person or a group of people) that is/are the subject of the alert. This may be accomplished using visible light or via projected infrared light, in which case the user may wear infrared sensitive glasses to see the alert. In the case where the detected dangerous situation involves one or more mobile objects (such as another vehicle, a person or a group of people, animal(s), etc.), in one example, AAV1 may also track the object(s) as the object(s) move and continue to illuminate the object(s).

In this same manner, AAV1 may project informative data for the user, such as navigational data for the route. Alternatively, or in addition, AAV1 may project content from a video call with an exercise coach or another. In the case where the projected content or information does not represent an urgent alert, AAV1 may make decisions about when and where to present the projected content. For instance, AAV1 may sense the surroundings of the user and make a determination that a “heads-up” projection would be safer at the moment than a “heads-down” one. For instance, if the user is detected to be approaching an intersection, AAV1 may either wait until the user is past the intersection or may only project visual content if AAV1 can locate a suitable flat surface for a heads-up view (e.g., a vertical surface, such as a side of a building, in the direction the user is moving).

In one example, AAV1 may also project a visible personal safety zone around/over the user. For instance, the visible personal safety zone may be projected via at least one lighting unit of AAV1, e.g., so as to surround the user with the visible light. In one example, the at least one lighting unit may comprise a projector that may also display information regarding the personal safety zone. For instance, the projector may cause the display of warning information, such as: “personal safety zone, this area is being recorded.” AAV1 may also monitor activity and objects that are near the perimeter of the personal safety zone using one or more of the AAV1's onboard sensors. Thus, for example, if a person is detected to be within a threshold distance of the perimeter (or already within the perimeter), AAV1 may emit an audible warning to alert the person or other nearby people to avoid the personal safety zone. Alternatively, or in addition, AAV1 may also cause the person near or within the perimeter to be illuminated via the same or a different lighting unit. In one example, the detected person may be illuminated in a different color of light from the personal safety zone, may be illuminated with a blinking pattern, or similar type of differentiation.

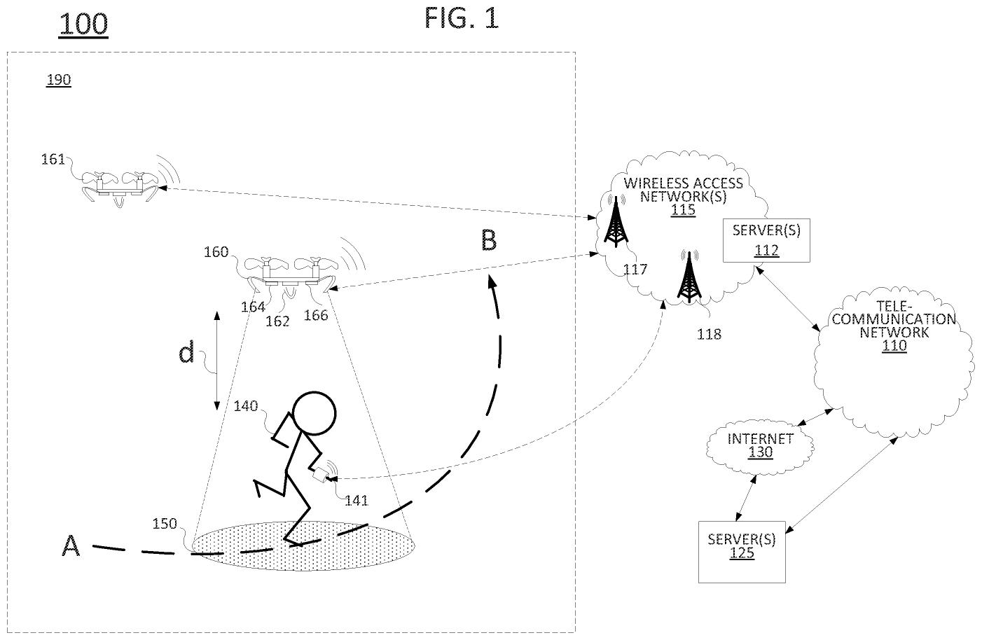

In one example, AAV1 may also summon a second AAV (AAV2) to assist when a dangerous situation is detected. For instance, AAV1 may continue to maintain a personal safety zone for the user, while directing AAV2 to track an object(s) or individual(s) and continue to illuminate the object(s) or individual(s). In still another example, the dangerous situation may not be one that affects the user, but may be for a different person. For instance, while detecting conditions along the route using onboard sensors, AAV1 may detect a dangerous situation of a car crash, a person in distress, etc. In such case, AAV1 may take several actions, such as alerting the user to provide assistance via an audible alert, via a visual projection on a surface, via a message to the user's wearable device, etc. In one example, AAV1 may transmit a video feed to a public safety entity. In one example, AAV1 may continue to mark the location of the incident, such as visible projection in the same or similar manner as the personal safety zone. In one example, the public safety interest may supersede the user's exercise session (e.g., if permitted by the user and/or if such superseding is compliant with pertinent local rules and regulations) and AAV1 may divert itself to the dangerous situation, e.g., until released by a public safety entity. However, in another example AAV1 may temporarily divert itself from supporting the user's exercise session, summon AAV2, and may revert to the user's exercise session when it is confirmed that AAV2 may take over (e.g., providing a visual feed, interacting with a public safety entity, etc.). These and other aspects of the present disclosure are discussed in greater detail below in connection with the examples of FIGS. 1-4.

To aid in understanding the present disclosure, FIG. 1 illustrates an example system 100, related to the present disclosure. As shown in FIG. 1, the system 100 connects user device 141, server(s) 112, server(s) 125, and autonomous aerial vehicles (AAVs 160-161), with one another and with various other devices via a core network, e.g., a telecommunication network 110, a wireless access network 115 (e.g., a cellular network), and Internet 130.

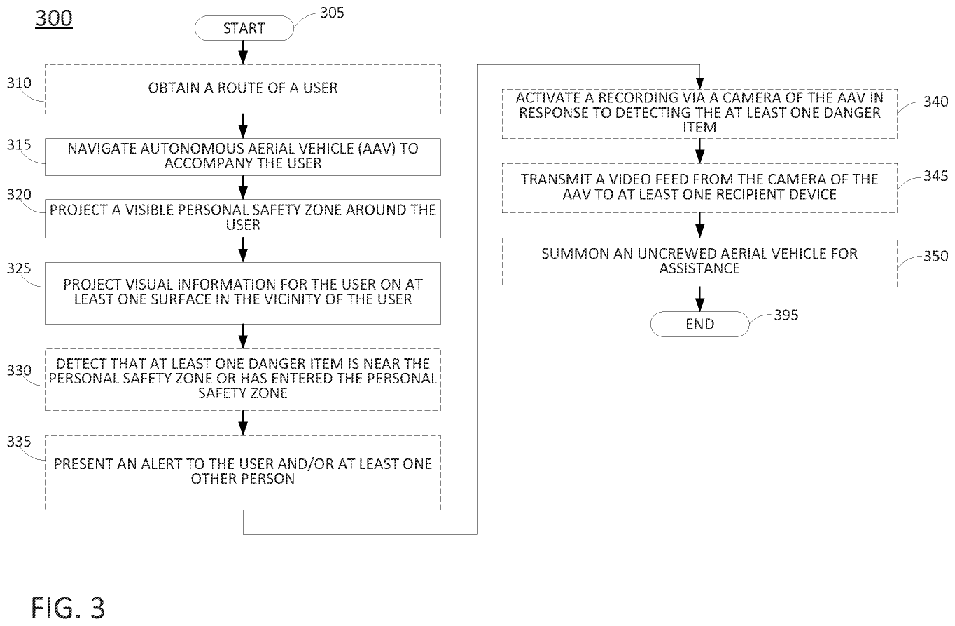

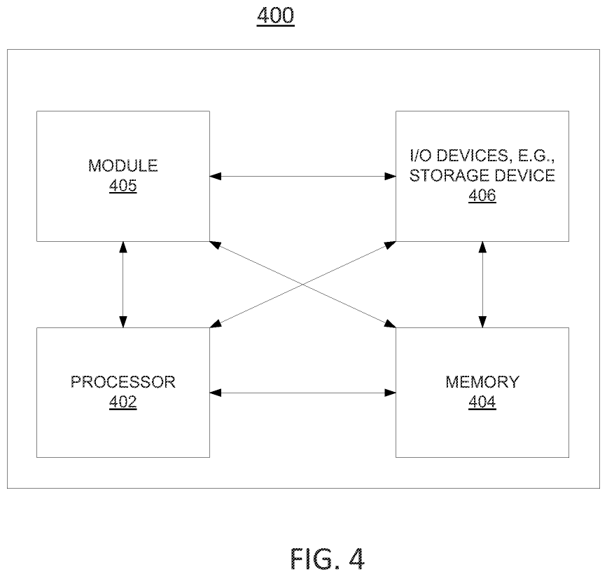

In one example, the server(s) 125 may each comprise a computing device or processing system, such as computing system 400 depicted in FIG. 4, and may be configured to perform one or more steps, functions, or operations for an autonomous aerial vehicle to project a visible personal safety zone around a user and to project visual information for the user on at least one surface. For instance, an example method for an autonomous aerial vehicle to project a visible personal safety zone around a user and to project visual information for the user on at least one surface is illustrated in FIG. 3 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, server(s) 125 may comprise an AAV fleet management system or a network-based AAV support service. For instance, server(s) 125 may receive and store information regarding AAVs, such as (for each AAV): an identifier of the AAV, a maximum operational range of the AAV, a current operational range of the AAV, capabilities or features of the AAV, such as maneuvering capabilities, payload/lift capabilities (e.g., including maximum weight, volume, etc.), sensor and recording capabilities, lighting capabilities, visual projection capabilities, sound broadcast capabilities, and so forth.

In one example, server(s) 125 may support AAVs in providing services accompanying users in outdoor exercise sessions. For instance, server(s) 125 may store detection models that may be applied to sensor data from AAVs, e.g., in order to detect dangerous situations, or the like. For instance, in one example, AAVs may include on-board processing systems with one or more detection models for detecting dangerous situations. However, as an alternative, or in addition, AAVs may transmit sensor data to server(s) 125, which may apply detection models to the sensor data in order to similarly detect such dangerous situations, or other situations.

In accordance with the present disclosure, “situations,” such as dangerous situations, are formalized. For example, signatures (e.g., machine learning models (MLM)) characterizing detectable situations may be stored. The “situations” may comprise detectable objects or items (and may include people or individuals) but may also include more complex scenarios, such as “car crash,” “burning house,” “brawl,” and so forth. The MLMs, or signatures, may be specific to particular types of sensor data, or may take multiple types of sensor data as inputs. For instance, with respect to images or video, the input sensor data may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a video and may include changes within images and between images in a sequence (e.g., video frames or a sequence of still image shots), such as color histogram differences or a change in color distribution, edge change ratios, standard deviation of pixel intensities, contrast, average brightness, and the like. In one example, an image salience detection process may be applied in advance of one or more situation detection models, e.g., applying an image salience model and then perform a situational detection over the “salient” portion of the image(s). Thus, in one example, visual features may also include a recognized object, a length to width ratio of an object, a velocity of an object estimated from a sequence of images (e.g., video frames), and so forth.

With respect to audio sensor data (e.g., captured via one or more microphones), a situation detection model, or signature, may be learned/trained based upon inputs of low-level audio features such as: spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth. Additional audio features may also include high-level features, such as: words and phrases. For instance, one example may utilize speech recognition pre-processing to obtain an audio transcript and to rely upon various keywords or phrases as data points.

As noted above, in one example, MLMs, or signatures, may take multiple types of sensor data as inputs. For instance, a “dangerous situation” of a “brawl” may be detected from audio data containing sounds of commotion, fighting, yelling, screaming, scuffling, etc. in addition to visual data which shows chaotic fighting or violent or inappropriate behavior among a significant number of people. Similar MLMs or signatures may also be provided for detecting dangerous situations based upon LiDAR input data, infrared camera input data, temperature sensor data, and so on.

In accordance with the present disclosure, a situational detection model may comprise a machine learning model (MLM) that is trained based upon the plurality of features available to the system (e.g., a “feature space”). For instance, one or more positive examples for a situation, or semantic content, may be applied to a machine learning algorithm (MLA) to generate the signature (e.g., a MLM). In one example, the MLM may comprise the average features representing the positive examples for a situation in a feature space. Alternatively, or in addition, one or more negative examples may also be applied to the MLA to train the MLM. The machine learning algorithm or the machine learning model trained via the MLA may comprise, for example, a deep learning neural network, or deep neural network (DNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. In one example, a trained situation detection model may be configured to process those features which are determined to be the most distinguishing features of the associated situation, e.g., those features which are quantitatively the most different from what is considered statistically normal or average from other situations that may be detected via a same system, e.g., the top 20 features, the top 50 features, etc.

In one example, a situation detection model (e.g., a trained MLM) may be deployed in AAVs, and/or in a network-based processing system to process sensor data from one or more AAV sensor sources (e.g., microphones, cameras, LiDAR, and/or other sensors of AAVs), and to identify patterns in the features of the sensor data that match the situation detection model(s). In one example, a match may be determined using any of the visual features and/or audio features mentioned above, e.g., and further depending upon the weights, coefficients, etc. of the particular type of MLM. For instance, a match may be determined when there is a threshold measure of similarity among the features of the sensor data streams(s) and the semantic content signature.

In one example, the system 100 includes a telecommunication network 110. In one example, telecommunication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In the present example, user device 141, AAV 160, and AAV 161 may be in communication with base stations 117 and 118, which provide connectivity between AAVs 160-161, user device 141, and other endpoint devices within the system 100, various network-based devices, such as server(s) 112, server(s) 125, and so forth. In one example, wireless access network(s) 115 may be operated by the same service provider that is operating telecommunication network 110, or one or more other service providers.

For instance, as shown in FIG. 1, wireless access network(s) 115 may also include one or more servers 112, e.g., edge servers at or near the network edge. In one example, each of the server(s) 112 may comprise a computing device or processing system, such as computing system 400 depicted in FIG. 4 and may be configured to provide one or more functions in support of examples of the present disclosure for an autonomous aerial vehicle to project a visible personal safety zone around a user and to project visual information for the user on at least one surface. For example, one or more of the server(s) 112 may be configured to perform one or more steps, functions, or operations in connection with the example method 300 described below. In one example, server(s) 112 may perform the same or similar functions as server(s) 125. For instance, telecommunication network 110 may provide a fleet management system, e.g., as a service to one or more subscribers/customers, in addition to telephony services, data communication services, television services, etc. In one example, server(s) 112 may operate in conjunction with server(s) 125 to provide an AAV fleet management system and/or a network-based AAV support service. For instance, server(s) 125 may provide more centralized services, such as AAV authorization and tracking, maintaining user accounts, creating new accounts, tracking account balances, accepting payments for services, etc., while server(s) 112 may provide more operational support to AAVs, such as deploying MLMs/detection models for detecting dangerous situations, for obtaining user location information (e.g., from a cellular/wireless network service provider, such as an operator of telecommunication network 110 and wireless access network(s) 115), and providing such information to AAVs, and so on. It is noted that this is just one example of a possible distributed architecture for an AAV fleet management system and/or a network-based AAV support service. Thus, various other configurations including various data centers, public and/or private cloud servers, and so forth may be deployed. For ease of illustration, various additional elements of wireless access network(s) 115 are omitted from FIG. 1.

As illustrated in FIG. 1, user device 141 may comprise, for example, a wireless enabled wristwatch. In various examples, user device 141 may comprise a cellular telephone, a smartphone, a tablet computing device, a laptop computer, a head-mounted computing device (e.g., smart glasses), or any other wireless and/or cellular-capable mobile telephony and computing devices (broadly, a “mobile device” or “mobile endpoint device”). In one example, user device 141 may be equipped for cellular and non-cellular wireless communication. For instance, user device 141 may include components which support peer-to-peer and/or short range wireless communications. Thus, user device 141 may include one or more radio frequency (RF) transceivers, e.g., for cellular communications and/or for non-cellular wireless communications, such as for IEEE 802.11 based communications (e.g., Wi-Fi, Wi-Fi Direct), IEEE 802.15 based communications (e.g., Bluetooth, Bluetooth Low Energy (BLE), and/or ZigBee communications), and so forth. In another example, user device 141 may instead comprise a radio frequency identification (RFID) tag that may be detected by AAVs.

In accordance with the present disclosure, AAV 160 may include a camera 162 and one or more radio frequency (RF) transceivers 166 for cellular communications and/or for non-cellular wireless communications. In one example, AAV 160 may also include one or more module(s) 164 with one or more additional controllable components, such as one or more: microphones, loudspeakers, infrared, ultraviolet, and/or visible spectrum light sources, projectors, light detection and ranging (LiDAR) units, temperature sensors (e.g., thermometers), and so forth. It should be noted that AAV 161 may be similarly equipped. However, for ease of illustration, specific labels for such components of AAV 161 are omitted from FIG. 1.

In addition, each of the AAVs 160 and 161 may include on-board processing systems to perform steps, functions, and/or operations for an autonomous aerial vehicle to project a visible personal safety zone around a user and to project visual information for the user on at least one surface, and for controlling various components of the respective AAVs. For instance, AAVs 160 and 161 may each comprise all or a portion of a computing device or processing system, such as computing system 400 as described in connection with FIG. 4 below, specifically configured to perform various steps, functions, and/or operations for an autonomous aerial vehicle to project a visible personal safety zone around a user and to project visual information for the user on at least one surface. For instance, an example method 300 for an autonomous aerial vehicle (broadly an autonomous vehicle) to project a visible personal safety zone around a user and to project visual information for the user on at least one surface is illustrated in FIG. 3 and described in greater detail below.

In an illustrative example, a user 140 having user device 141 (e.g., a wearable computing/communication device) may engage in an outdoor exercise session accompanied by AAV 160. In one example, the user 140 may request an AAV, such as transmitting a request to server(s) 125 and/or server(s) 112 (e.g., an AAV fleet management service) via user device 141. Server(s) 125 and/or server(s) 112 may then dispatch AAV 160 for the user 140. For instance, user 140 may have a subscription to an AAV service, or may pay on a per-use basis. In another example, AAV 160 may be owned or otherwise controlled by user 140. In one example, AAV 160 may be “paired” with user device 141. For instance, AAV 160 and user device 141 may establish a session or link via cellular or IEEE 802.11 based communications (e.g., Wi-Fi Direct, LTE Direct, a 5G device-to-device (D2D) sidelink, such as over a P5 interface, and so forth), via Dedicated Short Range Communications (DSRC), e.g., in the 5.9 MHz band, or the like, and so on. Alternatively, or in addition, AAV 160 and user device 141 may establish a communication session via one or more networks, e.g., via separate connections to wireless access network(s) 115. For illustrative purposes, it is assumed that AAV 160 and user device 141 are paired via a wireless peer-to-peer or sidelink session.

Continuing with the present example, user 140 may predefine an exercise route, such as from point A to point B illustrated in FIG. 1. In one example, user 140 may input the route to user device 141, which may provide various functions, such as tracking the user's location along the route and providing an indication on a map or a scroll graph showing the user's progress towards the finish (point B), providing an indication and/or tracking the user's pace/speed, number of steps, etc.). In one example, user device 141 may transmit the input route information to AAV 160. As such, in one example, AAV 160 may establish a separation distance, d, from user 140, and may attempt to generally maintain this separation distance for the duration of the exercise session. It should be noted that in another example, user 140 may set out without a predefined route, but may simply seek to get outside for a jog, for instance. In this case, AAV 160 may still attempt to maintain a general separation, d, from user 140, but may have some delay in responding if the user significantly changes directions during the session, e.g., when the user turns off of one road and onto another, the AAV 160 may take a moment to adjust to the user's new direction of movement before getting back on track and repositioning itself at the desired separation distance, d.

In one example, the AAV 160 may direct camera 162 toward the user 140 (e.g., toward the user device 141 based on a received signal from the user device 141) to record the exercise session. In addition, in one example, AAV 160 may track the position and pace of user 140 via the visual feed from camera 162. Alternatively, or in addition, a LiDAR unit of AAV 160 may be used to detect the user 140 and then to track the position and pace of user 140. Similarly, AAV 160 may track the position of user 140 via location information from user device 141 (which may include global positioning system (GPS) location/position, and which may further include speed and/or acceleration data). As such, AAV 160 may continue to move along with the user (e.g., on the route between A and B), while generally maintaining separation distance, d, in a desired lateral and/or vertical offset direction, or directions.

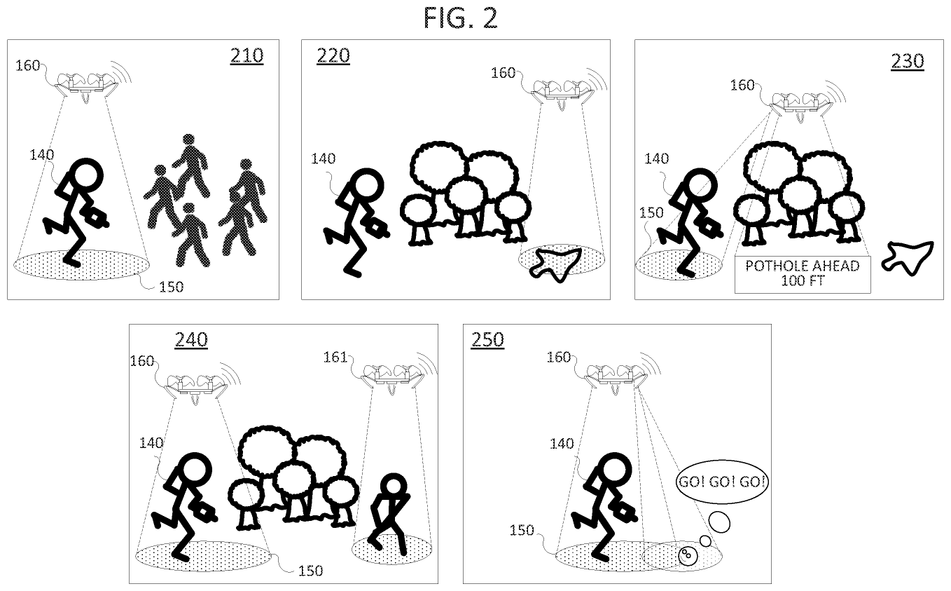

As further illustrated in FIG. 1, AAV 160 may project a personal safety zone 150 surrounding user 140. For instance, AAV 160 may use one or more on-board lighting systems and/or projector systems to project visible light around user 140 to create the personal safety zone 150. Notably, in one embodiment the visibility of the personal safety zone 150 may inform others in the vicinity that the user 140 has an expectation of personal space in at least the personal safety zone 150. In addition, the visibility of the personal safety zone 150 may also inform others that the area within the personal safety zone 150 is subject to image and/or video recording such that others nearby may avoid the personal safety zone 150 if they do not wish to be recorded. Notably, AAV 160 may provide additional services, in addition to recording images and/or video and projecting personal safety zone 150. FIG. 2 discussed in greater detail below, illustrates example scenes of AAV 160 accompanying user 140 during an exercise session, in accordance with the present disclosure.

The foregoing illustrates just one example of a system in which examples of the present disclosure for an autonomous aerial vehicle to project a visible personal safety zone around a user and to project visual information for the user on at least one surface may operate. It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 125 may alternatively or additionally be performed by server(s) 112, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for an autonomous aerial vehicle to project a visible personal safety zone around a user and to project visual information for the user on at least one surface. In still another example, servers(s) 112 may reside in telecommunication network 110, e.g., at or near an ingress node coupling wireless access network(s) 115 to telecommunication network 110, in a data center of telecommunication network 110, or distributed at a plurality of data centers of telecommunication network 110, etc. Additionally, devices that are illustrated and/or described as using one form of communication (such as a cellular or non-cellular wireless communications, wired communications, etc.) may alternatively or additionally utilize one or more other forms of communication. Thus, these and other modifications are all contemplated within the scope of the present disclosure.

FIG. 2 illustrates example scenes of an AAV accompanying a user during an exercise session, in accordance with the present disclosure. The examples of FIG. 2 may relate the same components as illustrated in FIG. 1 and discussed above. For instance, in a first example scene 210, AAV 160 is projecting personal safety zone 150 around user 140. As shown in the figure, there are a number of people nearby who may be informed or warned of the user 140's expectation of personal space, and that the area of personal safety zone 150 is or may be recorded via camera.

Notably, AAV 160 may provide additional services, in addition to recording images and/or video and projecting personal safety zone 150. For instance, as noted above, an AAV, such as AAV 160 may navigate at a distance, d, ahead of the user, and may use onboard sensors to detect conditions along the route. Scene 220 in FIG. 2 illustrates an example where AAV 160 may be ahead of user 140 and may detect that there is a pothole in the pavement. In one example, the pothole may be detected by collecting sensor data, such as camera images and/or video, LiDAR measurements, etc. and inputting the sensor data to one or more trained detection models (e.g., MLMs) such as described above. The MLMs may be stored and applied by an on-board processing system of AAV 160 in order to detect the dangerous situation (e.g., the pothole). In another example, AAV 160 may transmit collected sensor data to server(s) 112 and/or server(s) 125, which may apply the sensor data as inputs to one or more detection models, and which may respond to AAV 160 with any detected situations (e.g., the presence of the pothole). It should be noted that in still another example, one or more detection models may be possessed by AAV 160 and applied locally, while other detection models may remain in the network-based system components (e.g., server(s) 112 and/or server(s) 125) and may be applied in the network.

In any case, upon detection of the pothole, in one example, AAV 160 may notify user 140 by illuminating the pothole. It should be noted that a similar procedure may be applied with regard to detection of various other conditions, such as a presence of an animal, a sheet of ice over the pavement, rough terrain hidden in the dark, etc. It should also be noted that as shown in scene 220, the personal safety zone 150 is not present. For instance, AAV 160 may periodically scout ahead of user 140 and may travel further away such that the personal safety zone 150 is not projectable over the user 140. If and when no situation is detected, or after a defined period of time, e.g., 20 seconds, 30 seconds, etc., AAV 160 may return to the separation distance, d, and again project the personal safety zone 150. Alternatively, or in addition, the projection range of personal safety zone 150 may be shorter than the LiDAR object detection range of a LiDAR unit of AAV 160, or acoustic sensors/microphones of AAV 160. As such, in one example, AAV 160 may only depart further away from user 140 if there is a triggering condition that indicates further investigation is warranted, e.g., detection of objects, movement, etc. sounds of certain types or magnitudes, having received a public safety alert correlated to the immediate surrounding area of the user 140, etc.

Scene 220 shows AAV 160 notifying user 140 of a dangerous situation of a pothole by illuminating the pothole. The illumination may be via visible light, or may be via infrared light, in which case user 140 may wear infrared sensitive glasses/goggles in order to see the illumination of the pothole. In one example, AAV 160 may alternatively or additionally notify user 140 of the dangerous situation in one or more other ways. For instance, AAV 160 may present an audio warning via a loudspeaker of AAV 160. In another example, AAV 160 may transmit a message to the user device 141 to cause user device 141 to present a visual warning via a screen of user device 141 and/or an audible warning via a built-in speaker of user device 141 or an attached earphone or headset.

Alternatively, or in addition AAV 160 may project a visible warning as shown in scene 230. For instance, instead of hovering over and illuminating the pothole with visible or infrared light, AAV 160 may return to the user 140 and may project a warning message using a projector of AAV 160, such as: “pothole ahead 100 ft.” In this case, AAV 160 may continue to also project personal safety zone 150 around the user 140. It should be noted that the positioning of the projected warning information relative to the personal safety zone 150 is flexible and may vary depending upon the evaluation of AAV 160, the preferences of user 140, etc. For instance, the projection of the warning message may be inside the personal safety zone 150, depending upon the size of the personal safety zone 150. In addition, AAV 160 may detect one or more suitable flat surfaces for a projection, which may include relatively horizontal surfaces (e.g., the ground) and relatively vertical surfaces (e.g., a side of a building, a road sign, etc.), and may select one of the surfaces for the projection.

In a next example, scene 240 illustrates a situation where AAV 160 may detect a dangerous situation that does not directly affect user 140. Rather, the dangerous situation may affect another person, who may be in distress, such as having suffered an injury, e.g., a broken leg. For example, AAV 160 may have scouted ahead of user 140 along the route, e.g., similar to scene 220, but this time may detect the other person is in distress (e.g., via a respective MLM/detection model for “person in distress,” “person with broken limb,” or the like). In one example, AAV 160 may beckon a second AAV, e.g., AAV 161, to render assistance. For instance, AAV 160 may contact a network-based AAV fleet management system (e.g., server(s) 112 and/or server(s) 125) for dispatching another AAV, may contact a public safety entity, which may dispatch AAV 161, and/or may transmit a wireless broadcast for assistance which may be detected and acted upon by AAV 161 (e.g., via Wi-Fi Direct, LTE Direct, DSRC, 5G D2D or V2V, etc.). In one example, AAV 160 may remain with the person in distress until AAV 161 arrives, possibly illuminating the person to help other humans on the ground to locate the person. In one example, AAV 160 may notify the user 140 to render assistance, such as circling back to user 140 and presenting an audible message and/or a visually projected message (e.g., similar to scene 230), etc.

In still another example, scene 250 illustrates that in addition to projecting a personal safety zone 150, AAV 160 may also project visual information such as a video call/session with another person, e.g., a trainer or coach. For example, AAV 160 may establish a video call session with a device of the coach/trainer via one or more networks (e.g., at least wireless access network(s) 115). Alternatively, or in addition, user device 141 may establish a video call session with a device of the coach/trainer, and may forward the incoming call stream to AAV 160 via the session between user device 141 and AAV 160. In one example, an audio portion of the call may be presented via user device 141 (or an attached earphone/headset) while the video portion may be projected via AAV 160. In another example, the incoming audio from the coach/trainer may be presented via a speaker of AAV 160. As such, in one embodiment the coach/trainer may virtually accompany the user 140 during the exercise session, without being physically present. In one example, a trainer/coach video may be interrupted, the volume of the trainer/coach may be reduced, and/or the visual projection of the trainer/coach may be faded to draw the user attention to a present warning or other announcements. This could include making an additional projection or superimposing imagery indicating that there is an upcoming intersection, a turn in the route, danger ahead, etc., and/or presenting the same information in audible form. In one example, AAV 160 may simultaneously project multiple types of visual information, such as trainer/coach video call content accompanying a video call session with direction information, e.g., a next turn, or upcoming turns, etc., distance, speed, pace, heartrate or other information (some of which may be obtained via user device 141), and so on. In addition, it should be noted that the coach/trainer may lead a group exercise session in which users in diverse locations may exercise outside and traverse separate routes, while all being engaged with the coach/trainer (and in some cases, with each other). Thus, in one example, additional visual and/or audio data may be obtained from the coach/trainer device and/or a network-based system supporting a group call for the exercise session, which may include audio/visual information from one or more other users/participants.

It should be noted that the preceding scenes 210-240 may involve the projection of a coach/trainer call in addition to the already illustrated and described aspects. For instance, in scene 240, the user 140 may have the projection of a coach/trainer call in addition to personal safety zone 150 during the exercise session, which may then be interrupted with the detected dangerous situation of the other user in distress. As such, it should be noted that all of the foregoing examples are provided for illustrative purposes, and that other, further, and different examples may include more or less features, or may combine features in different ways in accordance with the present disclosure, such as using different detection models, utilizing and having different combinations of sensor data available, and so on.

FIG. 3 illustrates a flowchart of an example method 300 for an autonomous aerial vehicle to project a visible personal safety zone around a user and to project visual information for the user on at least one surface. In one example, steps, functions and/or operations of the method 300 may be performed by an AAV, such as AAV 160 or any one or more components thereof, or by AAV 160, and/or any one or more components thereof in conjunction with one or more other components of the system 100, such as server(s) 125, server(s) 112, elements of wireless access network 115, telecommunication network 110, one or more other AAVs (such as AAV 161), and so forth. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 (e.g., AAV 160) that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and may proceed to optional step 310 or to step 315.

At optional step 310, the processing system (e.g., of an autonomous aerial vehicle (AAV)) may obtain a route of a user, e.g., from a mobile computing device of the mobile user, such as a mobile smartphone, a wearable computing device, such as a smartwatch, smart glasses, etc., and so forth. The route may comprise an exercise route, such as an intended path for a walk, a jog, a run, bicycling, skating, etc. In one example, the AAV and the mobile device of the user may be “paired,” or establish a session or link via cellular or IEEE 802.11 based communications (e.g., Wi-Fi Direct, LTE Direct, a 5G device-to-device (D2D) sidelink, such as over a P5 interface, and so forth), via DSRC, and so on. Alternatively, or in addition, AAV 160 and user device 141 may establish a communication session via one or more networks. In another example, the user may enter a route via home computer prior to leaving for an exercise session. Alternatively, no route is received and the AAV is simply expected to follow the user and to maintain a predefined distance, d.

At step 315, the processing system navigates the AAV to accompany the user. For instance, the navigating may comprise maintaining a separation between the AAV and the user. In one example, the AAV may direct a camera toward the user (or toward the mobile computing device) to track the position and pace of user via the visual feed from the camera. In one example, the camera may also be active to record the exercise session. Alternatively, or in addition, a LiDAR unit of the AAV may be used to detect the user, and then to track the position of the user. Similarly, the AAV 160 may track the position of user via location information from the mobile computing device (e.g., GPS data). As such, the AAV may continue to move along with the user while generally maintaining a separation distance in a desired lateral and/or vertical offset direction, or directions.

At step 320, the processing system projects a visible personal safety zone around the user. In one example, the visible personal safety zone comprises at least a portion of a field of view of a camera of the AAV. In one example, the visible personal safety zone is projected via at least one lighting unit of the autonomous aerial vehicle (which may include a projector, light emitting diode (LED) lights, etc.). For instance, as noted above, the personal safety zone may be to inform others in the vicinity that the user has an expectation of personal space in the personal safety zone. In addition, the personal safety zone may also inform others that the area within the personal safety zone is subject to image and/or video recording such that others nearby may avoid the personal safety zone if they do not wish to be recorded.

At step 325, the processing system projects visual information for the user on at least one surface in the vicinity of the user, e.g., via a projector. In one example, the visual information for the user comprises directions for navigating along the route. In one example, the visual information for the user comprises a projection of a video call for the user. For instance, the video call may be maintained via a feed from the mobile computing device of the user, or may be established via a direct link between the autonomous aerial vehicle and a network access point. For instance, the video call may be for a coach/trainer to instruct or interact with the user. In one example, the video call may comprise a group video conference among three or more persons including the user, e.g., for a group exercise session with the users in diverse locations. In one example, the projection of visual information at step 325 may involve calculating a best place to project, which may often be on the ground out in front of the user, but could change or indicate that it will temporarily be suspended as user approaches a road intersection or other locations where the user should have independent focus and attention, or can switch to vertical surfaces or other locations deemed safe.

At optional step 330, the processing system may detect that at least one danger item (e.g., near the personal safety zone or in the personal safety zone). For instance, the danger item may comprise at least one object, animal, person and/or a situation that may be detected via at least one detection model based upon one or more types of sensor data collected by the AAV. For instance, AAV may capture image or video data from one or more camera, audio data from one or more microphones, temperature or other environmental data via respective sensors, LiDAR imaging/ranging data, and so forth. In one example, one or more detection models (e.g., MLMs) may be deployed in the AAV and may comprise or be accessible to the processing system, or may alternatively or additionally be deployed in a network-based processing system to process sensor data from one or more AAV sensor sources and to identify patterns in the features of the sensor data that match the detection model(s). In the latter case, optional step 330 may include transmitting sensor data from the AAV to the network-based processing system, and receiving a response that a danger item (e.g., object(s), animal(s), person(s) and/or a situation) is detected.

In one example, optional step 330 may include deviating from a separation distance towards the at least one danger item, recording the at least one danger item via a camera to create at least one recorded image, and determining at least one type of the at least one danger item via the at least one recorded image. For instance, AAV 160 may periodically scout ahead of the user and may then return to the separation distance, d, or be otherwise in closer proximity to the user. Alternatively, or in addition, the projection range of personal safety zone may be shorter than the LiDAR object detection range of a LiDAR unit of the AAV or acoustic sensors/microphones of the AAV. As such, in one example, the AAV may depart further from user if there is a triggering condition that indicates further investigation is warranted, e.g., detection of objects, movement, etc. sounds of certain types or magnitudes, and so forth (where the “detection” may not immediately resolve the actual type of object or situation as being a danger, but rather may comprise a coarse detection of some triggering condition). After closer inspection, the AAV may gather more sensor data relating to the object(s) or situation, and may detect the danger item, as such, based upon the collected sensor data and the detection model(s).

At optional step 335, the processing system may present an alert to the user (of the detected danger situation), wherein the alert comprises at least one of an audio component and/or a visual component. In one example, the alert may be presented via a mobile computing device of the user. In other words, the AAV may transmit a warning to the mobile computing device to cause the mobile computing device to present the alert. In one example, the visual component of the alert may comprise an infrared projection for detection by the user via infrared glasses of the user. In one example, optional step 355 may comprise broadcasting an audible warning. For instance, if the danger item is at least one person, the audible warning may alert the user of the presence of the at least one person, and may alert the at least one person that he or she is or may soon be violating the user's personal safety zone and may be subject to camera recording.

In one example, the alert may comprise a visual projection via a projector of the AAV. In this regard, it should be noted that the projection of visual information of step 325, such as a trainer/coach video call, may be stopped or interrupted, the volume may be reduced, and/or the visual projection of the trainer/coach may be faded to draw the user attention to the alert. This could include making an additional projection or superimposing imagery indicating the danger item and/or presenting the same information in audible form. In one example, the AAV may simultaneously project multiple types of visual information, such as trainer/coach images accompanying a video call session with direction information, e.g., a next turn, or upcoming turns, etc., distance, speed, pace, heartrate or other information (some of which may be obtained via the user's mobile computing device), and so on, all of which may be superseded by alerts regarding danger items. In addition, for visible projected alerts, the processing system may detect suitable surfaces for the projection and may direct the projection accordingly.

At optional step 340, the processing system may activate a recording via a camera and/or microphone of the AAV in response to detecting the at least one danger item (e.g., if the camera is not already recording the exercise session in general). In one example, optional step 340 may be performed prior to or at the same time as/in parallel to optional step 335.

At optional step 345, the processing system may transmit a video feed from the camera of the AAV to at least one recipient device, which may comprise the mobile computing device of the user, or a device of a safety monitoring system, such as a system of a public safety entity (e.g., police, fire, emergency medical services, a private security organization, etc.).

At step 350, the processing system may summon an uncrewed aerial vehicle for assistance. The uncrewed aerial vehicle may comprise another AAV, or may comprise a drone, e.g., operated by a ground-based (or otherwise remote-based) pilot. In one example, the summoning may comprise a broadcast or other transmissions via any of the modalities described above, e.g., Wi-Fi Direct, LTE Direct, DSRC, 5G D2D or V2V, etc. The assistance may be to track an object or objects (which may also be in motion), to mark the object(s) with IR or visible light, to track the user while the AAV continues to follow the object, etc. The assistance may depend upon the type of object detected, the level of the situation, a threat to the user or others, etc. For instance, a vehicle may enter the personal safety zone of the user and strike another pedestrian. While the user is unharmed, the AAV may alert one or more appropriate emergency services and provide assistance by summoning another uncrewed aerial vehicle, staying in the vicinity until help arrives, etc. In this case, although the AAV may be owned or otherwise controlled by the user, the terms-of-use or the law may require that the safety interest of others temporarily supersede the user's exercise session.

Following step 325, or one of optional steps 330-350, the method 300 may proceed to step 395. At step 395, the method 300 ends.

It should be noted that the method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-325, or steps 310-350 for additional exercise sessions, steps 330-335 for additional detected danger items, and so on. In one example, optional step 350 may alternatively or additional comprise summoning human assistance or summoning surface-operating autonomous vehicles. In still another example, the AAV may not strictly maintain a separation distance in a same direction from the user. For example, AAV may from time to time navigate in an arc, circle, or ellipse around the user to camera-record the user from different vantages. This may be pre-programmed, or may be in response to a user command or commands to engage in certain flight and/or recording maneuvers. In still another example, the user may not carry a mobile computing device during the exercise session, but may carry an RFID tag, RFID transponder, or the like, that may be detected by the AAV in order to track the user. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or described in connection with FIG. 2 or 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for an autonomous aerial vehicle to project a visible personal safety zone around a user and to project visual information for the user on at least one surface, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for an autonomous aerial vehicle to project a visible personal safety zone around a user and to project visual information for the user on at least one surface (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for an autonomous aerial vehicle to project a visible personal safety zone around a user and to project visual information for the user on at least one surface, in response to a bid from at least a second autonomous vehicle (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
navigating, by a processing system of an autonomous aerial vehicle, the autonomous aerial vehicle to accompany a user;
projecting, by the processing system, a visible personal safety zone around the user, wherein the visible personal safety zone comprises at least a portion of a field of view of a camera of the autonomous aerial vehicle; and
projecting, by the processing system, visual information for the user on at least one surface in a vicinity of the user.

2. The method of claim 1, further comprising:
obtaining a route of the user, wherein the navigating comprises navigating along the route.

3. The method of claim 2, wherein the route comprises an exercise route having a start location an end location.

4. The method of claim 2, wherein the visual information for the user comprises directions for navigating along the route.

5. The method of claim 1, wherein the visual information for the user comprises a projection of a video call for the user.

6. The method of claim 5, wherein the video call comprises a group video conference among three or more persons including the user.

7. The method of claim 1, wherein the visible personal safety zone is projected via at least one lighting unit of the autonomous aerial vehicle.

8. The method of claim 1, wherein the navigating comprises maintaining a predefined separation between the autonomous aerial vehicle and the user.

9. The method of claim 1, further comprising:
detecting at least one danger item is near the visible personal safety zone or is within the visible personal safety zone.

10. The method of claim 9, wherein the at least one danger item comprises at least one person, the method further comprising:
broadcasting an audible warning to alert the user and the at least one person.

11. The method of claim 9, further comprising:
activating a recording via the camera of the autonomous aerial vehicle in response to the detecting the at least one danger item.

12. The method of claim 9, further comprising:
transmitting a video feed from the camera of the autonomous aerial vehicle to at least one recipient device, wherein the at least one recipient device comprises a mobile computing device of the user, or a device of a safety monitoring system.

13. The method of claim 9, wherein the navigating comprises maintaining a predefined separation distance between the autonomous aerial vehicle and the user, wherein the detecting comprises:
deviating from the predefined separation distance towards the at least one danger item;
recording the at least one danger item via the camera of the autonomous aerial vehicle to create at least one recorded image; and
determining at least one type of the at least one danger item via the at least one recorded image.

14. The method of claim 9, further comprising:
summoning an uncrewed aerial vehicle for assistance.

15. The method of claim 9, further comprising:
presenting an alert to the user, wherein the alert comprises at least one of: an audio component or a visual component.

16. The method of claim 15, wherein the alert is presented via a mobile computing device of the user.

17. The method of claim 16, wherein the mobile computing device comprises a wearable computing device.

18. The method of claim 15, wherein the visual component of the alert comprises an infrared projection for detection by the user via a pair of infrared glasses of the user.

19. A non-transitory computer-readable medium storing instructions which, when executed by a processing system of an autonomous aerial vehicle including at least one processor, cause the processing system to perform operations, the operations comprising:
navigating the autonomous aerial vehicle to accompany a user;
projecting a visible personal safety zone around the user, wherein the visible personal safety zone comprises at least a portion of a field of view of a camera of the autonomous aerial vehicle; and
projecting visual information for the user on at least one surface in a vicinity of the user.

20. An apparatus comprising:
a processing system including at least one processor of an autonomous aerial vehicle; and
a computer-readable medium storing instructions which, when executed by the processing system, cause the processing system to perform operations, the operations comprising:
navigating the autonomous aerial vehicle to accompany a user;
projecting a visible personal safety zone around the user, wherein the visible personal safety zone comprises at least a portion of a field of view of a camera of the autonomous aerial vehicle; and
projecting visual information for the user on at least one surface in a vicinity of the user.
